(19) United States
(12) Patent Application Publication
(10) Pub. No.: US 2009/0132432 A1
(43) Pub. Date: May 21, 2009

(54) COMMODITY, PRICE AND VOLUME DATA SHARING SYSTEM FOR NON-PUBLICLY TRADED COMMODITIES

(76) Inventors: Rock L. Clapper, Palo Alto, CA (US); William Scott Lawley, Palo Alto, CA (US); Richard E. Kaiser, Palo Alto, CA (US)

Correspondence Address: Haynes and Boone, LLP;IP Section, 2323 Victory Avenue, SUITE 700, Dallas, TX, 75219, US

(21) Appl. No.: 12/241,625

(22) Filed: Sep. 30, 2008

Related U.S. Application Data
(60) Provisional application No. 60/997,032, filed on Oct. 1, 2007.

(51) Int. Cl. G06Q 40/00

(52) U.S. Cl. 705/36 R

(57) ABSTRACT

A system and a method are disclosed for gathering non-publicly available commodity data, processing the data, and distributing the processed information over the Internet or similar backbone in a delayed or real time manner. In particular, such a system provides technology and a process that gathers data from multiple operating systems and diverse software systems, receives the data in a central processing system, creates weighted averages, tickers, historical charts, and tables, and allows access to such from web-enabled devices.

### CROSS REFERENCE TO RELATED APPLICATIONS

The present application is related to and claims priority of U.S. provisional patent application (“Provisional Application”), entitled “Commodity, Price and Volume Data Sharing System for Non-Publicly Traded Commodities,” Ser. No. 60/997,032 filed on Oct. 1, 2007. The Provisional Application is hereby incorporated by reference herein.

### BACKGROUND OF THE INVENTION

1. Field of the Invention

The present invention relates to information gathering and processing. In particular, the present invention relates to gathering, processing and dissemination of data obtained from multiple systems of diverse hardware and software environments.

2. Discussion of the Related Art

Buyers and sellers of publicly traded commodities, including those grown, mined, and processed commodities, have sought to have last sale, volume and historical sales information at their fingertips since the beginning of trading history. As electronic data transfer matured, last sale price and current volume of publicly traded commodities became available via ticker tape, and then through computer-delivered systems. Publicly traded securities took a similar path. Real time and delayed information regarding current offerings of commodity and securities are available for a small fee, or in some cases, for free.

In addition to the raw transaction data, some systems offer additional data processing using algorithms which allows buyers and sellers to analyze the true price of the publicly traded commodity according to specific criteria. One such algorithm calculates a weighted average price, which is an average price that takes into account the actual amount of commodities transacted at each price. This technique prevents price information from being skewed by prices that are significantly different from the prices at which most transactions take place. For example, a transaction involving a large quantity of goods may be priced with a large volume discount. If left unweighted, buyers and sellers may be misled to believe that the average price is actually higher or lower.

Information regarding non-publicly traded commodities (e.g., price and volume), is typically found only in the private databases of buyers and sellers. Such information, which is both private and valuable, is typically proprietary and therefore such information is not shared with others. Information is generally passed between buyers and sellers verbally, which is also used as part of the negotiation process for these commodities.

Another reason sellers do not share information regarding non-publicly traded commodity is the participants' fear of being seen as colluding. In the United States, the Federal Trade Commission monitors and prosecutes collusion, which is an illegal act of unfair trade practice. For many years, commodity growers form various co-operatives (“coops”), in order to share best growing and selling practices, and to share selling prices for their commodities. Unfortunately, although the FTC has deemed coops to be a fair and legal method of sharing best practices, the sellers see each other as competition, and selling prices shared amongst coop members tend to be seen with skepticism.

Finally, even when coops have become well-organized, their ability to share crucial information in a timely manner is hampered by their failure to use technology that can provide real time or near real time price and volume information. In addition, as mentioned above, one seller may sell a large shipment at a discount and report the selling price, but since it was a large shipment at a discount, the price is depressed and can lead other sellers to start selling at a lower price than optimal.

### SUMMARY

According to one embodiment of the present invention, a system and a method are provided for gathering non-publicly available commodity data, processing the data, and distributing the processed information over the Internet or similar backbone in a delayed or real time manner. In that system, data is gathered from multiple operating systems and databases. A software system receives data in a central processing system to create processed data (e.g., weighted averages, tickers, historical charts, and tables) and allows access to the processed data from web-enabled devices.

Data is captured, processed and stored for later use. The data may be provided to users in the form of historical charts, tables and graphs, selected via familiar user interfaces (e.g., drop-down menus) for days, weeks, months, quarters and years, and also from one specified point in time to another specified point in time.

Sales information and related data (e.g., commodity type, price, volume, time, and date) are typically stored in an accounting system, an inventory management system, or similar database-enabled system by buyers, sellers, or both. Operating systems of information providers may be diverse and may include various versions of Microsoft, Unix, Linux, and many other operating systems that host accounting, inventory management, and related systems established to buy and sell non-publicly traded commodities. The information may be submitted in one or more formats to an information dissemination system via ftp, http, email and other electronic means over a secure or a non-secure network.

Once the commodity-related information is received, software algorithms examine the data to determine the required data manipulation necessary for creating measures of a true last-trade price and volume. One technique of the system uses a weighted average which blends small or large trades without skewing the data, even when the trades' prices were related to atypically large or small volumes. Once data is processed, the results are made available via tickers, charts, graphs, and in other readable text and graphical formats for easy consumption. The information is typically disseminated by a server connected to the Internet, Virtual Private Network, or some other secure network. Readable text and graphical information are made available via the Internet to users using web-enabled devices. These devices include, but are not limited to, wired and wireless devices with web browsers, such as cellular phones, desktop and laptop computers, and personal digital assistants.

### BRIEF DESCRIPTION OF THE DRAWINGS

FIG. 1 depicts the overall schematic and workflow of the system for aggregating, processing and distributing non-publicly traded commodities, in accordance with one embodiment of the present invention.

### DETAILED DESCRIPTION OF PREFERRED EMBODIMENTS

The following definitions are adopted herein to facilitate illustration of the specific embodiments described in detail herein:

| Term | Definition |
|---|---|
| Data provider | An entity that buys or sells non-publicly traded |
| | commodities |
| End user | An individual who buys or sells commodities, or |
| | is an interested party to such transactions |
| The System | A computer running various programs to receive, |
| | process and distribute information related to non- |
| | publicly traded commodities |
| Algorithm | A computer program that calculates using a finite |
| | set of well-defined instructions for accomplishing |
| | specified tasks which, given an initial state, will |
| | terminate in a corresponding recognizable end- |
| | state. |
| Secure transmission | Any method for moving data from one computer |
| | to another using data protection technology |
| Web-enabled device | Any wired or wireless device that contains a |
| | browser or a similar technology for displaying |
| | data |
| Web application | A software program that is written to display |
| | information on a browser or a similar technology |

The present invention provides technology and a process that gathers data from multiple operating systems and diverse software systems, receives the data in a central processing system, creates weighted averages, tickers, historical charts, and tables, and allows access to such processed data from web-enabled devices. These processes, systems, and techniques are well-suited for data sharing for non-publicly traded commodities.

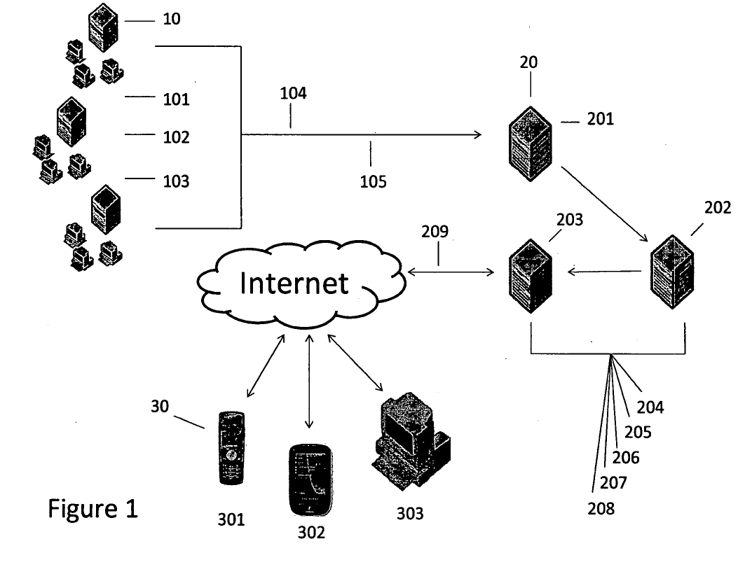

FIG. 1 is a schematic depiction of the data sharing system for non-publicly traded commodities, according to one embodiment of the present invention. As shown in FIG. 1, a data aggregation or collection system 10 receives data from accounting systems 101 and inventory management systems 102. Accounting systems 101 and inventory management systems 102 may be, for systems, systems used by buyers or sellers in one or more markets where commodities are bought and sold in their normal course of business. As each transaction in these markets is typically negotiated privately between the seller and the buyer individually and does not take place on a public exchange market place, the information contained in these systems is generally inaccessible by the public. Accounting systems 101 and inventory management systems 102 may be based on proprietary systems or may be commercially available enterprise management information systems. Such systems may store data in different formats and reside on different operating systems 103. The data that is retrieved from such systems by data aggregation and collection system 10 may be, for example, commodity identifications, transaction prices, transaction volumes, time of day and date of the transactions, and other indices related to transactions. Data aggregation and collection system 10 may retrieve this data using ftp, email, http and other forms of packet exchange protocols over the Internet or another wide area data network (indicated by reference numeral 104), with or without additional levels of secure data transmission protocols (indicated in FIG. 1 by reference numeral 105; e.g., virtual private network).

The collected data is then provided to computer system 20, which may provide the services of raw data receiver 201, raw data processor 202, and a number of data distribution services, or web applications 203. These services may be provided by one or more connected computers. For example, computer system 20 may reside on computer hardware or networked servers 204, and may be provided with operating systems 205 that are appropriate for and consistent with the expected operations of the servers. Operating systems 205 may include Unix, Linux, and Microsoft operating systems.

Software 206 is specific to the tasks of receiving and processing raw data and distributing the processed data. Software 206 may be software written using standardized programming languages, such as C, C++, and Java, for which development tools (e.g., compilers for various software and hardware platforms) are readily available. Such software may incorporate, for example, algorithms to compute weighted averages¹, to compile daily and other volumes, and to provide analytical tools for discovering and examining historical trends, and other functions. The results of the algorithms (indicated by reference numeral 207) are presented to users in the form of charts, tables, graphs, last trade tickers and other processed data. Web-applications are provided to allow access of the results over the Internet (indicated by reference numeral 209). Alternatively, the data may be “pushed” to subscribers, as appropriate, over the Internet. ¹ A weighted average may be calculated by, for example, for all the included transactions, summing the products of price and transaction volume and divide the resulting sum by the total volume of the included transactions.

Results 207 of the processing in software 206 (e.g., processing using algorithms 207) are made available to users through web applications 208 over the Internet (209). The users may examine the processed data using web-enabled devices 30, including, for example, cellular telephones 301, personal digital assistants 302, and desktop and laptop computers 303. Web-enabled devices typically provide to users graphical user interfaces, including software popularly known as “browsers,” for accessing the data over the Internet.

Therefore, the present invention allows parties with an interest in the buy and sell transactions in non-publicly traded commodity markets to observe such transactions. These parties may include, for example, cooperatives interested in sharing information regarding transactions of goods bought or sold by their members. The members may be interested, for example, in finding transaction volumes throughout the trading day as well as the current or most recent prices. In addition, other interested parties include companies or individuals interested in tracking trends in non-publicly traded commodities, for example, for such purposes as providing insurance to traders or providing financial instruments to traders.

Further, the present invention allows governments or other institutional entities to collect data, track trading practices, or to project industry trends in industries with non-publicly traded commodities.

The above detailed description is provided to illustrate the specific embodiments of the present invention and is not intended to be limiting. Numerous variations and modifications within the scope of the present invention are possible. The present invention is set forth in the following claims.

We claim:

1. A method for gathering data regarding transactions involving non-publicly traded commodities, comprising:
retrieving the data over a wide area network from computer systems under control of one or more parties to each of the transactions;
aggregating the data to process, for each commodity, price, volume and statistical data regarding the transactions; and
making available the processed data over a publicly accessible data network.

2. A method as in claim 1, wherein the computer systems comprise disparate operating systems and databases.

3. A method as in claim 2, wherein the computer systems comprise inventory management systems.

4. A method as in claim 2, wherein the computer systems comprise accounting systems.

5. A method as in claim 2, wherein the computer systems comprise enterprise information systems.

6. A method as in claim 1, further comprising providing the retrieved data, including one or more category selected from commodity types, transaction prices, volumes, transaction dates, and transaction times.

7. A method as in claim 1, wherein the processed data are presented in one or more forms selected from charts, graphs, tables, and tickers based on live or historical data.

8. A method as in claim 1, wherein the wide area network comprises a virtual private network.

9. A method as in claim 1, wherein data is provided over the publicly access data network in real time.

10. A method as in claim 1, wherein the statistical data comprises a weighted average transaction price.

11. A method as in claim 1, wherein the data is retrieved from accounting systems on the computer systems.

12. A method as in claim 1, wherein the processed data is accessed using web-based applications.

13. A method as in claim 12, wherein the web-based applications are accessed from a mobile device.

14. A method as in claim 13, wherein the mobile device is one of cellular telephone, laptop computers and personal digital assistants.

15. A method as in claim 1, wherein the processed data is sent from a server to subscribers.

16. A system for gathering data regarding transactions involving non-publicly traded commodities, comprising:
a data collection system for retrieving data over a wide area network from computer systems under control of one or more parties to each of the transactions;
a data processing system coupled to the data collection system over the wide area network to process the data to provide, for each commodity, price, volume and statistical data regarding the transactions; and
a server which makes available the processed data over a publicly accessible data network.

17. A system as in claim 16, wherein the computer systems comprise disparate operating systems and databases.

18. A system as in claim 17, wherein the computer systems comprise inventory management systems.

19. A system as in claim 17, wherein the computer systems comprise accounting systems.

20. A system as in claim 11, wherein the computer systems comprise enterprise information systems.

21. A system as in claim 16, wherein the server provides the retrieved data, including one or more category selected from commodity types, transaction prices, volumes, transaction dates, and transaction times.

22. A system as in claim 16, wherein the processed data are presented in one or more forms selected from charts, graphs, tables, and tickers based on live or historical data.

23. A system as in claim 16, wherein the wide area network comprises a virtual private network.

24. A system as in claim 16, wherein the data provided over publicly access data network is real time data.

25. A system as in claim 16, wherein the statistical data comprises a weighted average transaction price.

26. A system as in claim 16, wherein the data is retrieved from accounting systems on the computer systems.

27. A system as in claim 16, wherein the processed data is accessed using web-based applications.

28. A system as in claim 27, wherein the web-based applications are accessed from a mobile device.

29. A system as in claim 28, wherein the mobile device is one of cellular telephone, laptop computers and personal digital assistants.

30. A system as in claim 16, wherein the processed data is sent from a server to subscribers.
